(19) United States
(12) Patent Application Publication
(10) Pub. No.: US 2011/0024356 A1
(43) Pub. Date: Feb. 3, 2011

(54) SEPARATION CARTRIDGES AND METHODS FOR FABRICATION AND USE THEREOF

(75) Inventor: Can C. Ozbal, Maynard, MA (US)

Correspondence Address: EDWARDS ANGELL PALMER & DODGE LLP, P.O. BOX 55874, BOSTON, MA, 02205, US

(73) Assignee: BIOCIUS LIFE SCIENCES, INC., Wakefield, MA (US)

(21) Appl. No.: 12/905,496

(22) Filed: Oct. 15, 2010

Related U.S. Application Data
(63) Continuation of application No. PCT/US2009/041771, filed on Apr. 27, 2009.
(60) Provisional application No. 61/125,466, filed on Apr. 25, 2008.

(51) Int. Cl. B01D 15/08; G01N 30/00; C08J 3/28

(52) U.S. Cl. 210/656; 210/282; 522/160

(57) ABSTRACT

Embodiments of the invention provide separation cartridges, methods for fabricating separation cartridges, and methods for using separation cartridges. One aspect of the invention provides a separation cartridge including a first end, a second end, and one or more sorbents located between the first end and the second ends, the one or more sorbents arranged from the first end to the second end in order of increasing hydrophobicity. Another aspect of the invention provides a method of creating a separation cartridge having varying hydrophobicity. The method includes loading a filtration material and a cross-linking agent into a cylinder and selectively exposing the material to an energy source to selectively initiate a cross-linking reaction within the filtration material.

### RELATED APPLICATIONS

This application claims priority to U.S. Provisional Patent Application Ser. No. 61/125,466, filed Apr. 25, 2008. The contents of this patent application are hereby incorporated by reference in their entirety.

### TECHNICAL FIELD

Embodiments of the invention provide separation cartridges, methods for fabricating separation cartridges, and methods for using separation cartridges.

### BACKGROUND

The analysis of chemical or biological samples in the solution phase is of great importance in a wide range of applications. In many applications, such as drug discovery and development, environmental testing, diagnostics, etc., there is a need to analyze a large number of samples in an efficient and reproducible manner. Many of the techniques used to analyze solution phase samples require the samples to be interrogated serially, where each sample is tested in a sequential manner. A desirable method for analyzing samples quantitatively is mass spectrometry (MS), a method that can interrogate complex mixtures and quantify selected analytes based on the molecular mass of those analytes.

Modern mass spectrometers using ionization techniques such as electrospray ionization (ESI) or atmospheric pressure chemical ionization (APCI) can be used to directly interrogate samples in solutions. However, sensitive and accurate quantification by MS requires the samples to be purified and separated from high concentrations of salts, buffers, and other ionic compounds. High concentrations of ions in the sample to be analyzed can lead to a phenomenon known as ion suppression wherein the analytes of interest are masked by the presence of other ions. Additionally, non-volatile components within the sample tend to precipitate in the source region of the mass spectrometer and will degrade MS performance. High concentrations of salts and buffer that are not purified will eventually result in the MS failing completely.

Liquid chromatography (LC) is a commonly used technique to purify analytes prior to MS analysis. Many types of liquid chromatography are used including, but not limited to, high-pressure liquid chromatography (HPLC), ultra high-pressure liquid chromatography (LTPLC), and solid phase extraction (SPE). These purification techniques work through the differential chemical properties of the individual analytes within a complex sample. The chemical properties used to isolate or purify analytes of interest may include polarity, hydrophobicity, ionic strength, charge, size, or molecular structure. In each of these techniques, a solid sorbent is packed into a column or cartridge and the complex mixture is flowed over the sorbent allowing for interactions between the analyte(s) of interest and the sorbent to take place.

In many analyses, a large number of different compounds that greatly range in their chemical properties need to be analyzed. Examples of such analyses include applications in the drug development process in which it is very important to characterize the properties of potential drug candidates. Many assays are performed to determine the potential suitability of drug candidates such as solubility assays, metabolic stability assays, membrane permeation assays, plasma protein binding assays, toxicity assays, determinations of pharmacokinetic and pharmacodynamic properties, and the like. All of these assays require the quantification of a given test compound over time or space. The assays require either the presence of high ionic strength buffers that mimic physiological conditions or are actually performed in cells or intact organisms. Accurate MS-based quantification relies on a sample purification step prior to analysis.

The need to interrogate large numbers of different chemicals in a fast, economical, and efficient manner poses a challenge to researchers, Developing a unique analytical method for each analyte to be interrogated is typically not a desirable option as method development can be a time and resource consuming process. As a result, one or more standard or generic methods are typically applied to the entire set of test compounds with the hope that many of them will work at an acceptable level. For example a set of test compounds may be purified prior to MS analysis by solid-phase extraction based on the polarity affinity of the analytes. A hydrophobic (i.e. non-polar) SPE sorbent (e.g., a C18 material) may be selected. The analytes may be loaded onto the SPE material and washed with an aqueous solution. It is hoped that the analyte(s) of interest will adsorb or bind to the hydrophobic SPE sorbent while salts, buffers, and other ions will wash through the resin. The analyte(s) of interest can then be eluted from the SPE sorbent using an organic solvent (e.g., acetonitrile, methanol, or others) that may contain an ion pairing agent (e.g., trifluoroacetic acid). The eluted analyte(s) that are separated from the water soluble salts, buffers, and other ions can then be quantified with a detector such as a mass spectrometer.

It is understood that if a large number of test compounds are attempted to be purified with a standard analytical method (such as HPLC or SPE), many of the analyses will fail because the test compounds of interest will not possess the appropriate chemical properties for that analytical method. For example, if a sorbent with low hydrophobicity (e.g., a C4 or cyano phase resin) is selected, many polar compounds will not adhere to the sorbent and will be washed through the sorbent along with the salts and buffers. Similarly, if an SPE resin with very high hydrophobic potential (e.g., a C18 or a phenyl resin) is selected, many non-polar test compounds will adsorb irreversibly on the sorbent and either will not be eluted at all or only a small amount of the analyte will actually elute off of the sorbent. One solution is to use several different standard analytical purification methods that cover a wider range of chemical properties with the hope that some test compounds that fail in one analytical method will succeed in another. However, such approaches have heretofore been expensive and time consuming.

Accordingly, there is a need for a device capable of purifying a variety of samples having varying properties.

### SUMMARY OF THE INVENTION

Embodiments of the invention provide separation cartridges, methods for fabricating separation cartridges, and methods for using separation cartridges.

One aspect of the invention provides a separation cartridge including a first end, a second end, and one or more sorbents located between the first end and the second ends, the one or more sorbents arranged from the first end to the second end in order of increasing hydrophobicity.

This aspect can have a variety of embodiments. The separation cartridge can include a first fit located adjacent to the first end and a second frit located adjacent to the second end. The frits are adapted to retain the one or more sorbents. The one or more sorbents can be arranged in a plurality of regions. Each region has a distinct hydrophobicity. The separation cartridge can include one or more frits for separating the plurality of regions. The one or more sorbents can be selected from the group consisting of: cyano resin, C1 resin, C2 resin, C3 resin, C4 resin, C8 resin, C18 resin, phenyl resin, biphenyl resin, graphictic carbon, cyanopmpyl, and trimethylsilane. The separation cartridge can include a cylinder. The cylinder encapsulates the one or more sorbents. The cylinder can be a metal cylinder.

Another aspect of the invention provides a separation cartridge including: an inlet located at one end of the separation cartridge, a first sorbent region adjacent to the inlet, a second sorbent region adjacent to the first sorbent region, a third sorbent region adjacent to the second sorbent region, a fourth sorbent region adjacent to the third sorbent region, a fifth sorbent region adjacent to the fourth sorbent region, and an outlet located at the other end of the separation cartridge adjacent to the fifth sorbent region.

This aspect can have a variety of embodiments. The first sorbent region can include cyano resin. The second sorbent region can include C4 resin. The third sorbent region can include C8 resin. The fourth sorbent region can include C18 resin. The fifth sorbent region can include phenyl resin.

Another aspect of the invention provides a method of creating a separation cartridge having varying hydrophobicity. The method includes loading a filtration material and a cross-linking agent into a cylinder and selectively exposing the material to an energy source to selectively initiate a cross-linking reaction within the filtration material.

This aspect can have a variety of embodiments. The cylinder can be a glass tube or a fused silica tube. The energy source can be a light source or a radiation source. The filtration material can include a polymer and a cross-linking agent.

Another aspect of the invention provides a method of filtration including: providing a separation cartridge including a cylinder having a first end and a second end and one or more sorbents located within the cylinder between the first end and the second ends, the one or more sorbents arranged from the first end to the second end in order of increasing hydrophobicity; flowing a sample through the cartridge from the first end to the second end, wherein one or more analytes in the solution are adsorbed in the one or more sorbents; and flowing a solvent from the second end to the first end, thereby eluting the one or more analytes from the one or more sorbents.

This aspect can have a variety of embodiments. The method can include presenting the solvent and the one or more analytes to a detector. The detector can be a mass spectrometer. The one or more sorbents can be arranged in a plurality of regions, each region having a distinct hydrophobicity. The one or more sorbents can be selected from the group consisting of: cyano resin, C1 resin, C2 resin, C3 resin, C4 resin, C8 resin, C18 resin, phenyl resin, biphenyl resin, graphictic carbon, cyanopropyl, and trimethylsilane.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1A is a schematic diagram of a cartridge containing a continuous gradient of increasing hydrophobic sorbent according to one embodiment of the invention.

FIG. 1B is a schematic diagram of a cartridge containing a plurality of distinct sorbent regions according to one embodiment of the invention.

FIG. 2 is a schematic diagram of a system for purifying a sample.

FIG. 3 is a flowchart depicting the operation of a universal separation cartridge according to one embodiment of the invention.

FIG. 4 depicts a method of manufacturing a cartridge having a substantially continuous increase in hydrophobicity from a first end to a second end according to one embodiment of the invention.

### DETAILED DESCRIPTION

Embodiments of the current invention provide for cartridges having a variable hydrophobicity such that a single analytical method can be applicable to a very wide range of test compounds. A single cartridge that is compatible for a large range of test compounds enables the rapid and efficient analysis of many assays can have a significant impact on drug discovery and development, environmental analysis, and diagnostic applications.

As used herein the term “cartridge” refers to modular unit designed to be inserted into a larger piece of equipment such as a liquid chromatography apparatus, a solid phase extraction apparatus, and high-throughput autosampler. As such, a cartridge can in many embodiments serve the same function as existing columns used in such systems.

Embodiments of the cartridge are designed to be used in an apparatus wherein sample loading and washing occurs in a direction opposite of the sample elution. Such a system is described in U.S. Patent Application Publication Nos. 2005/0123970 and 2005/0194318. One advantage of such “reverse elution” devices is minimization of linear diffusion because the analytes of interest do not travel though the entire length of the cartridge and thus are not subjected to turbulence, Minimization of linear diffusion facilitates elution of the analytes in a very sharp band that produces a narrow chromatographic peak, Narrow chromatographic peaks are highly desirable because eluting the same amount of analyte in a narrow peak results in an enhanced peak height thereby increasing the signal-to-noise ration of the apparatus. Furthermore, peak width is the ultimate determinant of the overall throughput of the apparatus as baseline resolution of peaks from individual samples is required.

Embodiments of the invention include a sorbent packed into a cartridge that contains a very hydrophilic material at the sample inlet side. The hydrophobicity of the sorbent increases throughout the cartridge until it becomes very hydrophobic at the exit end of the cartridge. When a sample is loaded onto the cartridge at the sample inlet side it will move through the sorbent until it reaches a portion of the sorbent where the analyte(s) of interest are adsorbed onto the sorbent. If the analyte is very non-polar, it may adsorb to a hydrophilic region of the cartridge close to the column inlet. Similarly, if the analyte is highly polar it may penetrate into column until it adsorbs to a very hydrophobic region of the column near the exit of the column.

To elute the analytes, the flow direction is switched and an organic elution solvent (e.g., acetonitrile, methanol, and the like) is flowed through the cartridge in the opposite direction. The analyte(s) are desorbed off of the resin and elute back through the inlet end of the cartridge.

One advantage of the invention is that a very non-polar analyte will never come into contact with the hydrophobic regions of the cartridge where it may become irreversibly bound. Similarly, many polar compounds can still be purified with the same method and column since they will simply penetrate into the hydrophobic region of the cartridge where the polar compounds will be reversibly adsorbed.

In one embodiment of the invention, a number of individual cartridges or subcartridges, each containing a single sorbent chemistry, are arranged in fluidic communication with each other in a single arrangement with decreasing polarity.

In other embodiments, the cartridge can contain different regions of distinct sorbents, which can, in some embodiments, be separated by a frit or filter to maintain their spatial orientation. Alternatively, the cartridge can contain a cross-linked polymeric resin that, rather than distinct regions of increasing hydrophobicity, has a substantially continuous gradient of hydrophobicity. A single cartridge containing either distinct regions of decreasing polarity or a continuous polarity gradient is particularly advantageous because the over size of the cartridge is minimized vis-à-vis multiple cartridges, thereby minimizing linear diffusion and narrowing chromatographic peaks.

In some embodiments, the sorbent is encased within a steel or similar rigid material to ensure that the cartridge is able to maintain high pressure that may be applied. In other embodiments, the sorbent is encased in glass, plastic, or other materials. In some embodiments, a filter or frit at either end of the tube ensures that the polymeric resin will be retained within the cartridge.

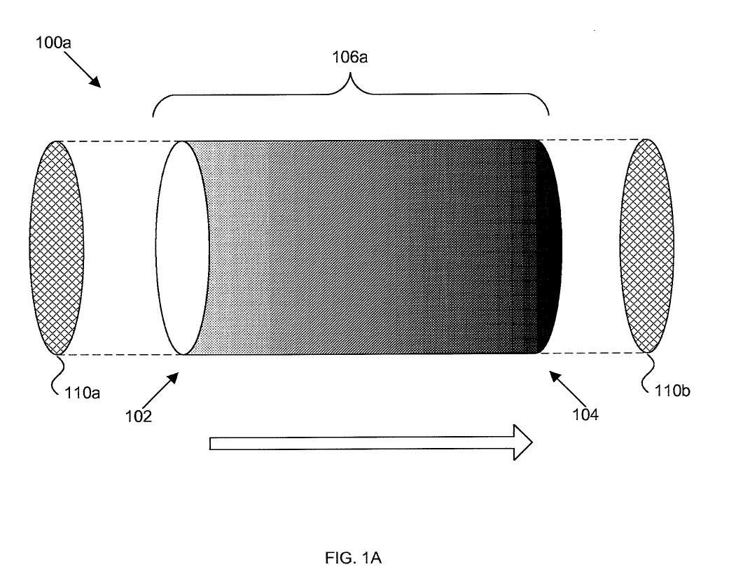

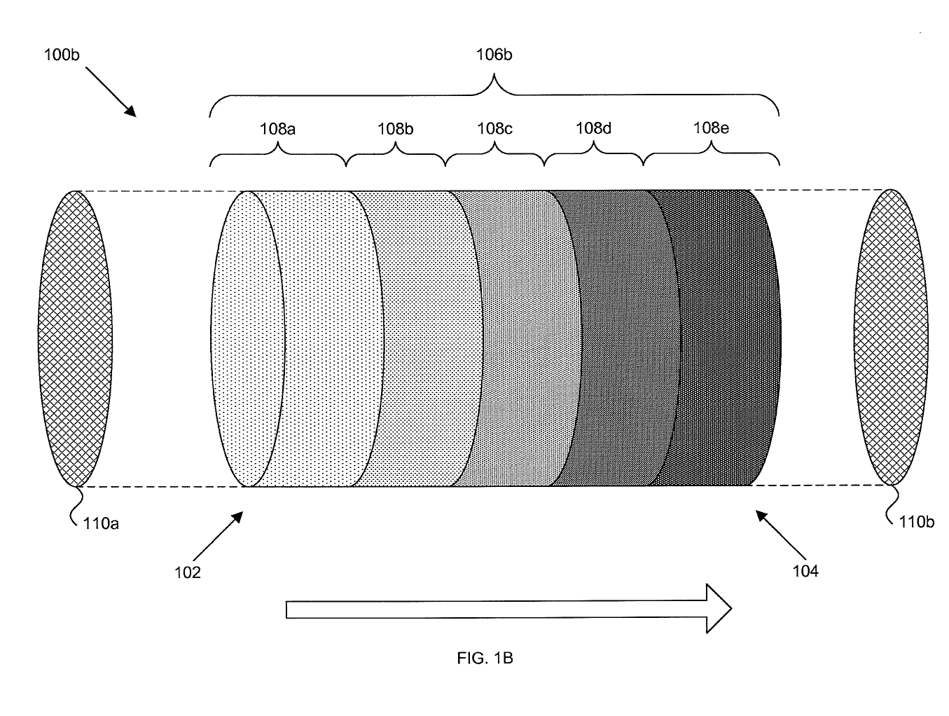

Referring now to FIG. 1A, a cartridge 100a according to one embodiment of the invention is provided. Cartridge 100a has a first end 102 and a second end 104 and a sorbent 106a located between the first end 102 and second end 104. The sorbent is arranged such that the hydrophobicity of the sorbent 106a increases from one end of the cartridge 100 to the other end of the cartridge. For example, the sorbent 106 can increase in hydrophobicity from first end 102 to second end 104, as represented visually by darkening shading of sorbent 106a in FIG. 1A.

The increase in hydrophobicity of the sorbent can be substantially continuous as depicted in FIG. 1A. Alternatively, as depicted in FIG. 1B, cartridge 100b can include a plurality of distinct regions 108a-e of sorbent 106b, each region 108a-e having a substantially uniform hydrophobicity.

In some embodiments, cartridges 100a, 100b can include one or more frits 110a, 110b to retain sorbent within cartridge 100a, 100b. The frits 110a, 110b can be located at the ends 102, 104 and/or between one or more regions 108a-e to prevent undesired sorbent movement. Frits can be composed of materials such as glass, plastics (e.g., polyethylene), metals (e.g., stainless steel or titanium), and the like.

One embodiment includes two distinct sorbent zones within a single cartridge separated by a frit. The two distinct zones include a more polar region at the proximal end of the cartridge and a less polar region at the distal end of the cartridge.

Such a cartridge can be simply manufactured without greatly altering the overall volume or linear diffusion of the apparatus as compared to a cartridge with a single sorbent. A frit is placed in the center of an empty cartridge. The two distinct sorbents can then be sequentially slurry-packed under pressure from either end of the cartridge. The packed sorbent can be sealed within the cartridge by placing additional frits at either end of the cartridge.

Cartridges 100 can include a plurality of sorbents 106. As discussed herein, the sorbents can be arranged in order of increasing or decreasing hydrophobicity. Some embodiments of the invention can contain only two distinct sorbents while others can include a series of sorbents with slightly different characteristics, For example, referring again to FIG. 1B, region 108a can be a cyano resin, region 108b can be a C4 resin, region 108c can be a C8 resin, region 108d can be a C18 resin, and region 108e can be a phenyl resin. As is known to those of skill in the art, resins such as “C18 resin” refer to stationary phases bonded to silica. There are a variety of other reversed phase stationary phases that could be readily included in the current invention including C1, C2, and C3 resins that have minimal hydrophobic character or biphenyl phases that are extremely hydrophobic. One or more regions of the cartridge could also include less commonly employed specialty reversed phases such as graphictic carbon, cyanopropyl, trimethylsilane (TMS) functionality.

Stationary phases including non-silica supports can also be employed either alone or in conjunction with regions using silica-based sorbents. Such stationary phases can include polymeric and/or gel-based matrices. Polymeric stationary phases typically are comprised of a copolymer of polystyrene and divinyl benzene. By varying the amount of divinyl benzene copolymer, the hydrophobicity of the cartridge can be attenuated. A wide range of polymeric stationary phases are commercially available from a number of vendors. Hydrophobicities similar to that of conventional silica-based cartridges can be obtained by modifying the amount of copolymer with hydrophobic character in accordance with a variety of well-known and proprietary methods.

In other embodiments of the invention, the cartridge includes one or more normal phase stationary phases. For example, the plurality of sorbents can include a region with weak ion exchange resin and a region with a strong ion exchange resin. Examples of weak ion exchange resins include carboxylic acids and ternary amines. Examples of strong ion exchangers include sulfonic acid and quaternary amino groups. In this embodiment, a single cartridge can be used to retain a wide range of compounds based on their acidic or basic properties.

In yet another embodiment of the invention, hydrophilic interaction chromatography (HILIC) sorbents of increasing potency could be used in the cartridge. Examples of typical HILIC resins include unmodified silica, unmodified alumina, silanol, diol, amine, amide, cationic, or zwitterionic bonded phases.

### Operation of Universal Separation Cartridge

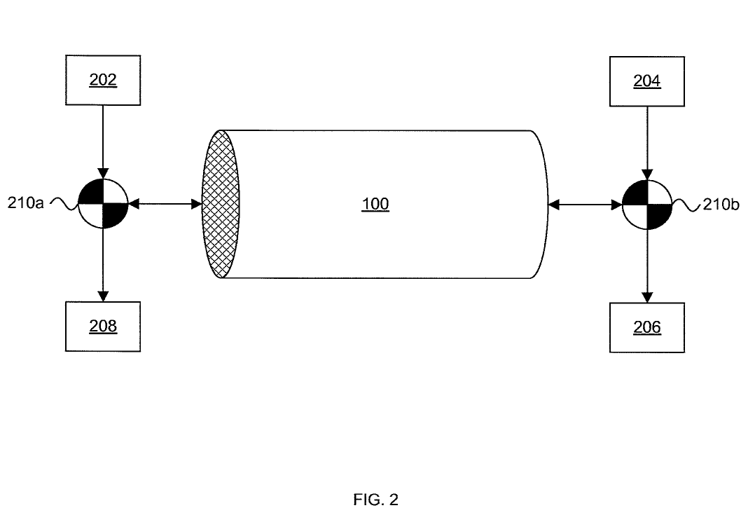

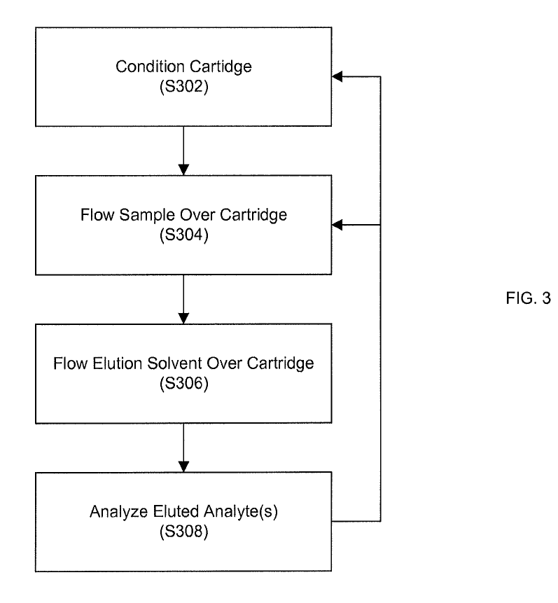

FIGS. 2 and 3 depict the operation of a universal separation cartridge according to embodiments of the invention. Cartridge 100 is coupled to a sample source 202, a waste collector 204, a solvent source 206, and a detector 208. The flow of fluids over the cartridge 100 can be controlled by one or more valves 210a, 210b.

In some embodiments of the invention, the cartridge is “conditioned” by flowing a conditioning solvent over the cartridge prior to flowing a sample over the cartridge (S302). Conditioning solvents can include one or more polar and/or non-polar liquids such as methanol followed by water or an aqueous buffer, Conditioning wets the packing material in the cartridge and solvates the functional groups of the sorbent(s) 106.

In step S304, a test compound from sample source 202 is flowed over the cartridge 100 in a first direction (e.g., left to right in FIG. 2). One or more analytes of interest (e.g., non-polar compounds) bind to the hydrophilic sorbent(s) in the cartridge 100, while ionic compounds are washed through the cartridge 102 and captured in waste collector 204.

In step S306, an organic solvent (e.g., acetonitrile, methanol, and the like) from solvent source 206 is then flowed over the cartridge 100 in a second direction (e.g., right to left in FIG. 2) to elute the analyte of interest from the cartridge 100.

In step S308, the eluted analyte(s) are then presented to detector 208 for analysis. Detector can include a variety of devices such as mass spectrometer. A wide variety of mass spectrometers are available from companies such as Agilent Technologies, Inc, of Santa Clara, Calif.; PerkinElmer, Inc, of Waltham, Mass.; Applied Biosystems, Inc, of Foster City, Calif.; Shimadzu Corporation of Kyoto, Japan; Thermo Fisher Scientific Inc, of Waltham, Mass.; Waters Corporation of Milford, Massachusetts; and Varian, Inc, of Palo Alto, Calif.,

### Fabrication of Variable Hydrophobicity Columns

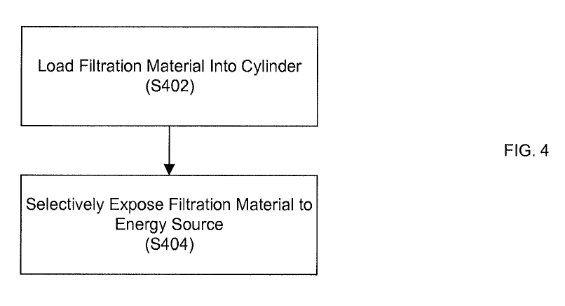

FIG. 4 depicts a method 400 of manufacturing a cartridge 100a having a substantially continuous increase in hydrophobicity from a first end to a second end as depicted in FIG. 1A.

Such a column can be manufactured by cross-linking a polymer with a cross-linking agent that contains a very hydrophobic group. The amount of cross-linking in the polymer will dictate the amount of the hydrophobic potential of the resin. Suitable reversed-phase systems are comprised of a copolymer of styrene and divinyl benzene. The relative amount of the highly hydrophobic divinyl benzene copolymer dictates the overall characteristic of the resin.

In step S402, a cylinder is loaded with a filtration material and a cross-linking agent into a cylinder. In step S404, the filtration material and the cross-linking agent are selectively exposed to an energy source to selectively initiate a cross-linking reaction within the filtration material.

In one embodiment of the invention, the cross-linking reaction is initiated by light or ultraviolet radiation. The polymer and cross-linking reagent are loaded into a cartridge manufactured from a material that is transparent to the light or radiation used to initiate the cross-linking reaction (e.g., a glass or fused silica tube). The regions of the cartridge at the inlet end that are to be hydrophilic are exposed to radiation at low dose or for a short time and the amount of exposure to the radiation will be increased along the length of the column.

### Application to High-Throughput Autosamplers

The cartridges, systems, and methods herein can readily be applied to high-throughput autosamplers that facilitate the rapid loading, elution, and presentation of sample to a detector (e.g., a mass spectrometer). Such devices are available under the RAPIDFIRE® trademark from BioTrove, Inc. of Woburn, Mass. and are described in U.S. Patent Application Publication Nos. 2005/0123970 and 2005/0194318.

### EQUIVALENTS

The foregoing specification and the drawings forming part hereof are illustrative in nature and demonstrate certain preferred embodiments of the invention. It should be recognized and understood, however, that the description is not to be construed as limiting of the invention because many changes, modifications and variations may be made therein by those of skill in the art without departing from the essential scope, spirit or intention of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A separation cartridge comprising:
a first end;
a second end; and
one or more sorbents located between the first end and the second ends, the one or more sorbents arranged from the first end to the second end in order of increasing hydrophobicity.

2. The separation cartridge of claim 1, further comprising:
a first frit located adjacent to the first end; and
a second frit located adjacent to the second end, the frits adapted to retain the one or more sorbents.

3. The separation cartridge of claim 1, wherein the one or more sorbents are arranged in a plurality of regions, each region having a distinct hydrophobicity.

4. The separation cartridge of claim 3, further comprising one or more frits for separating the plurality of regions.

5. The separation cartridge of claim 1, wherein the one or more sorbents are selected from the group consisting of: cyano resin, C1 resin, C2 resin, C3 resin, C4 resin, C8 resin, C18 resin, phenyl resin, biphenyl resin, graphictic carbon, cyanopropyl, and trimethylsilane.

6. The separation cartridge of claim 1, further comprising:
a cylinder, the cylinder encapsulating the one or more sorbents.

7. The separation cartridge of claim 6, wherein the cylinder is a metal cylinder.

8. The separation cartridge of claim 1, wherein the one or more sorbents comprise:
a first sorbent region adjacent to the first end;
a second sorbent region adjacent to the first sorbent region;
a third sorbent region adjacent to the second sorbent region;
a fourth sorbent region adjacent to the third sorbent region;
a fifth sorbent region adjacent to the fourth sorbent region and the outlet.

9. The separation cartridge of claim 8, wherein:
the first sorbent region comprises cyano resin;
the second sorbent region comprises C4 resin;
the third sorbent region comprises C8 resin;
the fourth sorbent region comprises C18 resin; and
the fifth sorbent region comprises phenyl resin.

10. A method of creating a separation cartridge having varying hydrophobicity, the method comprising:
loading a filtration material and a cross-linking agent into a cylinder; and
selectively exposing the material to an energy source to selectively initiate a cross-linking reaction within the filtration material.

11. The method of claim 10, wherein the cylinder is a glass tube.

12. The method of claim 10, wherein the cylinder is a fused silica tube.

13. The method of claim 10, wherein the energy source is a light source.

14. The method of claim 10, wherein the energy source is a radiation source.

15. The method of claim 10, wherein the filtration material comprises:
a polymer; and
a cross-linking agent.

16. A method of filtration comprising:
providing a separation cartridge comprising:
a cylinder having a first end and a second end; and
one or more sorbents located within the cylinder between the first end and the second ends, the one or more sorbents arranged from the first end to the second end in order of increasing hydrophobicity;
flowing a sample through the cartridge from the first end to the second end, wherein one or more analytes in the solution are adsorbed in the one or more sorbents; and
flowing a solvent from the second end to the first end, thereby eluting the one or more analytes from the one or more sorbents.

17. The method of filtration of claim 16, further comprising:
presenting the solvent and the one or more analytes to a detector.

18. (canceled)

19. The method of filtration of claim 16, wherein the one or more sorbents are arranged in a plurality of regions, each region having a distinct hydrophobicity.

20. The method of filtration of claim 16, wherein the one or more sorbents are selected from the group consisting of: cyano resin, C1 resin, C2 resin, C3 resin, C4 resin, C8 resin, C18 resin, phenyl resin, biphenyl resin, graphictic carbon, cyanopropyl, and trimethylsilane.

21. The separation cartridge of claim 1, wherein the one or more sorbents comprise a single sorbent having a substantially continuous gradient of hydrophobicity.
